(19) United States
(12) Patent Application Publication
(10) Pub. No.: US 2008/0050947 A1
(43) Pub. Date: Feb. 28, 2008

(54) Double-ended press-fit connector

(76) Inventors: Chiharu Nunokawa, Tokyo (JP); Satoshi Iijima, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/892,373

(22) Filed: Aug. 22, 2007

(30) Foreign Application Priority Data
Aug. 25, 2006 (JP) 2006-229056

(51) Int. Cl. H01R 12/16

(52) U.S. Cl. 439/82; 439/638; 439/76.1

(57) ABSTRACT

A double-ended press-fit connector that enables the efficiency with which the connector is mounted on a printed circuit board to be improved. The connector has an insulated housing in which are arranged multiple fixing holes for inserting contacts and multiple press-fit contacts that are inserted in the fixing holes. The press-fit contacts have at least bulge portions formed to a width of maximum extent at a center in the long direction of the contacts and press fit portions formed in the shape of an arc in a width direction at both end sides thereof. Shoulder portions that form steps are provided at top and bottom ends of the bulge portions, and the fixing holes in the insulated housing are formed to a shape that accommodates engagement of the press-fit contacts and stops the contacts from slipping out of the insulated housing.

### BACKGROUND OF THE INVENTION

1. Field of the Invention

The present invention relates to a press-fit connector provided with press-fit contacts having press-fit portions that are pressed into through-holes in a printed circuit board, and more particularly, to a double-ended press-fit connector that provides at both ends press-fit contacts having press-fit portions on an insulated housing.

2. Related Art

Conventionally, when mounting a connector provided with a plurality of contacts on a printed circuit board, the connector is soldered and fixedly attached to the printed circuit board. Recently, however, in an effort to make the mounting operation solder-free or more efficient, a press-fit connector provided with press-fit contacts in which the contacts of one end side are pressed into through-holes in the printed circuit board so as to effect an electrical connection has come to be known (see, for example, JP-A-2001-148271 and JP-A-2005-158507).

With a press-fit connector provided with such press-fit contacts, press-fit portions are inserted into through-holes in the printed circuit board while contact portions are contacted against the contacts of another connector. Therefore, in this case, the press-fit connector acts as an electrical connection between the printed circuit board and the other connector. By contrast, the conventional example shown in FIGS. 6A and 6B is that of a double-ended press-fit connector 10 for use between boards, in which a press-fit connector 12 having press-fit portions 12a, 12b on both end sides is fixedly attached to an insulated housing 11, and the press-fit portions 12a, 12b are each mounted on printed circuit boards.

In the double-ended press-fit connector 10 described above, projections 13 and 14 indicating polarity of press-fit direction are provided on each of top and bottom surfaces of the insulated housing 11 as shown in FIG. 6A. As shown in FIG. 6B, in order to press the press-fit contacts 12 into the insulated housing 11 and fixedly attach the press-fit connector thereto, a shoulder portion 12d of the press-fit portion 12a side is pressed in a direction of an arrow in the drawing using a press-fit jig. This is done because engagement portions 12c, 12c intended to engage the insulated housing 11 exist only on one end side in a long direction of the contact.

When mounting the double-ended press-fit connector 10 on the printed circuit board, as shown in FIG. 7 and FIG. 8, first, a printed circuit board 15 is placed on a receiving jig 17, and the press-fit portions 12b of the side that has the engagement portions 12c in the connector 10 is pressed into the printed circuit board 15. Specifically, the press-fit portions 12b are aligned with through-holes 15a in the printed circuit board 15 and, as shown in FIG. 9, a punch jig 18 is used to press the shoulder portions 12d so as to press the press-fit contacts 12 and fixedly mount the connector on the printed circuit board 15.

Next, as shown in FIG. 10A, a printed circuit board 16 is then placed on top of the connector 10 with through-holes 16a aligned with the press-fit portions 12a on the top side of the connector and the printed circuit board 16 is pressed with the punch jig 18 so as to press the press-fit portions 12a into the printed circuit board 16. With the pressing of the punch jig 18, friction generated by sliding contact between the through-holes 16a and the press-fit portions 12a presses the press-fit contacts 12 downward. However, the shoulder portions 12e of the press-fit contacts 12 strike a stepped portion of the insulated housing 11, and thus the press-fit contacts 12 do not slip out from the insulated housing 11.

In addition, as shown in FIG. 10B, in some cases the insulated housing 11 and the printed circuit board 15 are turned upside down from the fixed state achieved using the method shown in FIG. 9 and are pressed into the printed aboard 16 which is placed on top of the receiving jig 17 using the punch jig 18. In this case also, the shoulder portions 12e of the press-fit contacts 12 are pressed against the stepped portion of the insulated housing 11, and therefore the press-fit contacts 12 do not slip out of the insulated housing 11.

However, as shown in FIG. 11, when the press-fit portions 12a of the press-fit contacts 12, that is, the press-fit portions 12a on the side that has no engagement portions 12c, are first pressed into the through-holes 15a in the printed circuit board 15 placed on top of the receiving jig 17 using the punch jig 18 to press the shoulder portions 12e through the stepped portion of the housing 11, a problem arises.

Specifically, as shown in FIG. 12A, when the printed circuit board 15 and the double-ended press-fit connector 10 are placed on the receiving jig 17 and the through-holes 16a in the printed circuit board 16 are aligned with the press-fit portions 12b and the printed circuit board 16 is pressed with the punch jig 18, the press-fit contacts 12 slip out of the insulated housing 11. This is because there is nothing like the shoulder portion 12e present to offer support when the double-ended press-t connector 10 is pressed downward by the friction generated by the sliding contact between the press-fit contacts 12 and the through-holes 16a.

In addition, as shown in FIG. 12B as well, the position shown in FIG. 12A is simply turned upside down, and therefore, as described above, the press-fit contacts 12 slip out of the insulated housing 11 because the punch jig 18 presses the double-ended press-fit connector 10 through the printed circuit board 15 and insulated housing 11, and cannot directly press the shoulder portion 12d of the double-ended press-fit connector 10.

Thus, as described above, in the double-ended press-fit connector 10 according to the conventional example, unless the press-fit portions 12b on the side that has the engagement portions 12c of the press-fit contacts 12 are pressed into the printed circuit board 15 first, they will slip out of the insulated housing 11 of the connector 10. Consequently, in order to prevent that problem from occurring, it is necessary to provide the connector 10 with the projections 13, 14 indicating polarity as shown in FIG. 6A. In addition, it is necessary to provide the jigs 17, 18 with escape holes to accommodate the polarity projections 13, 14.

### SUMMARY OF THE INVENTION

Accordingly, the double-ended press-fit connector according to the present invention is conceived in light of the problem of the conventional art described above, and is proposed in order to provide a double-ended press-fit connector that does not require the polarity projections described above and does not lead to problems if the order in which the press-fit portions of the press-fit contacts are pressed into the printed circuit board is reversed, in other words, a double-ended press-fit connector that enables the efficiency with which the connector is mounted on the printed circuit board to be improved.

To solve the above-described problem and achieve the above-described object, a double-ended press-fit connector of the present invention is comprised of an insulated housing in which multiple fixing holes for insertion of contacts are aligned and a plurality of press-fit contacts inserted in the fixing holes. The press-fit contacts each have at least a bulge portion of maximum width at a center of the press-fit contact in a long direction and a press-fit portion at each end side of the press-fit contact, with each press-fit portion formed in an arc shape in a width direction of the press-fit contact. Shoulder portions that form steps are provided at top and bottom ends of the bulge portion, with the fixing holes formed in a shape so as to accommodate engagement of the press-fit contacts and stop the press-fit contacts from slipping out of the insulated housing.

The stoppage at the shoulder portions becomes even more secure if the bulge portion is rectangular in shape, and thus a rectangular shape is preferable. In addition, if engagement portions having slight projections are provided on both outer sides between the bulge portion and the press-fit portion a click sensation is obtained at the same time that the stoppage becomes even more secure, enabling completion of insertion to be confirmed and thus facilitating the mounting operation.

Further, preferably, the insulated housing is divided into two parts, upper and lower, along the center of the press-fit contact in the long direction of the press-fit contact, with the fixing holes provided in each of the upper and lower parts formed so as to be vertically symmetrical. Such a construction enables the press-fit contacts to be inserted into each of the fixing holes from inside the housing divided into upper and lower parts, so that the shoulder portions of the bulge portion contacts the insulated housing and the contacts are fixed in place without moving in either direction.

The insulated housing may be molded as a single integrated unit together with the press-fit contacts. By arranging and fixing in place predetermined press-fit contacts inside a mold and pouring an insulation synthetic resin into the mold, the press-fit contacts can be completed in a single operation, thus enabling the work of assembly involving pressing the press-fit contacts into the fixing holes to be omitted.

Preferably, each of the press-fit contacts has on a tip end side of the press-fit portion an introductory portion of narrower width than the press-fit portion. Such a construction facilitates the work of inserting the press-fit contacts into the fixing holes in the insulated housing.

According to the double-ended press-fit connector of the present invention, the press-fit contacts installed inside the insulated housing are prevented from slipping out in either long direction by the shoulder portion formed into a bulge portion, and therefore the problem of the contacts slipping out of the housing does not arise regardless of the order of assembly. Therefore, it is no longer necessary to provide polarity projections indicating the order of assembly on the insulated housing, and further, it is no longer necessary to provide escape holes to accommodate the polarity projections in the press jig, and therefore production costs can be reduced. Moreover, when inserting the contacts in the printed circuit board, there is no need to be concerned about the direction of press-fit insertion, and thus the efficiency of the mounting operation improves.

Other objects, features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1A is a front view of a double-ended press-fit connector according to the present invention;

FIG. 1B is a partial longitudinal section view of the double-ended press-fit connector;

FIG. 2 is a sectional view of mounting the double-ended press-fit connector on a first printed circuit board using a jig;

FIG. 3A is a sectional view of mounting the double-ended press-fit connector on a second printed circuit board using a jig;

FIG. 3B is a sectional view of the double-ended press-fit connector mounted on the first printed circuit board turned upside down for mounting on the second printed circuit board;

FIG. 4 is an overall perspective view of mounting the double-ended press-fit connector on two printed circuit boards using a jig;

FIG. 5 is an overall vertical sectional view of mounting the double-ended press-fit connector on two printed circuit boards using a jig;

FIG. 6A is a front view of a conventional double-ended press-fit connector;

FIG. 6B is a partial longitudinal section view of the conventional double-ended press-fit connector;

FIG. 7 is an overall perspective view of mounting the conventional double-ended press-fit connector on two printed circuit boards using a jig;

FIG. 8 is an overall vertical sectional view of mounting the conventional double-ended press-fit connector on two printed circuit boards using a jig;

FIG. 9 is a sectional view of mounting the conventional double-ended press-fit connector on a printed circuit board using a jig;

FIG. 10A is a sectional view of mounting the conventional double-ended press-fit connector on a second printed circuit board using a jig;

FIG. 10B is a sectional view of the conventional double-ended press-fit connector mounted on a first printed circuit board turned upside down for mounting on the second printed circuit board;

FIG. 11 is a sectional view of pressing a press-fit portion on a side that does not have an engagement portion first when pressing the conventional double-ended press-fit connector into a printed circuit board using a jig;

FIG. 12A is a sectional view of mounting the conventional double-ended press-fit connector on the second printed circuit board using a jig; and

FIG. 12B is a sectional view of the conventional double-ended press-fit connector mounted on the first printed circuit board turned upside down for mounting on the second printed circuit board.

### DETAILED DESCRIPTION OF THE PREFERRED EMBODIMENTS

A detailed description will now be given of a preferred embodiment of the present invention, with reference to the accompanying drawings.

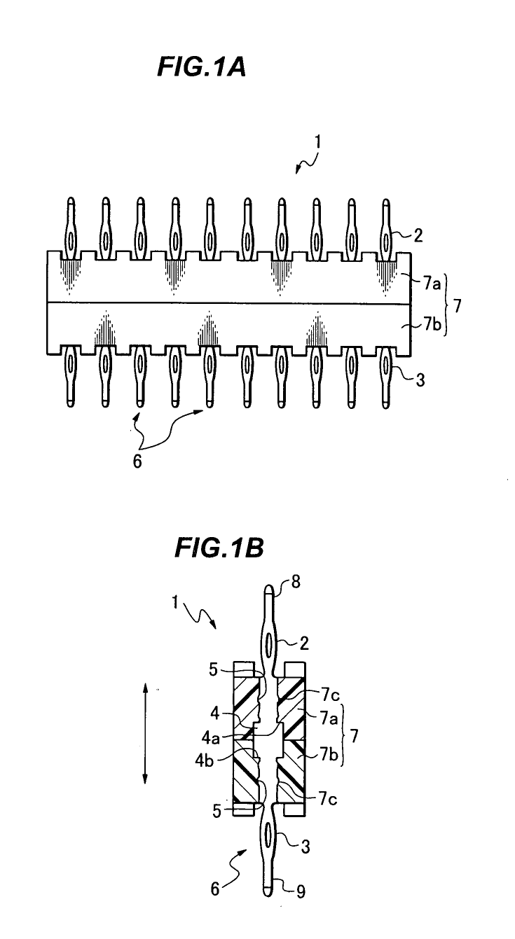

As shown in FIG. 1A and FIG. 1B, a double-ended press-fit connector 1 according to the present invention is comprised of a plurality of press-fit contacts 6, 6 . . . and an insulated housing 7 for press-fitting and fixing in place the press-fit contacts 6, 6. The insulated housing 7 is made of insulating synthetic resin, and is divided into two parts, upper and lower, so as to be comprised of a pair of sections 7a, 7b. Fixing holes for the purpose of press-fitting and fixing in place the press fit contacts 6 are formed in each of the sections 7a, 7b so as to be vertically symmetrical. The press-fit contacts 6 are pressed and inserted into the fixing holes 7c in the sections 7a, 7b.

The press-fit contacts 6 are formed by being punched out of thin metal plate with a mold, and therefore have on both tip end portions in their long direction introduction portions 8, 9 of narrower width so as to facilitate insertion in the fixing holes 7c; press-fit portions 2, 3 formed so as to bulge elliptically in a width direction on an inside of the introductory portions 8, 9; and a bulge portion 4 of maximum width at a central portion thereof. In addition, between the bulge portion 4 and the press fit portions 2, 3, engagement portions 5, 5 are formed on both outer sides so as to project slightly outward. It should be noted that the insulated housing 7 is divided into upper and lower parts at a center in the long direction of the bulge portion 4.

Like sewing machine needles, the press-fit portions 2, 3 have an expanded portion that bulges outward in the width direction in the shape of an oval, in which a similarly shaped slit is formed. The bulge portion 4, in the embodiment shown in the drawing, is formed in the shape of a rectangle of width wider than that of the engagement portion 5, with a shoulder portion 4a formed between it and the engagement portion 5. The shoulder portion 4a is a press-fit contact 6 slip-stop prevention means.

The engagement portion 5 is comprised of multiple projections, and once the press-fit contacts 6 are pressed and mounted, the engagement of the projections prevents the contacts from slipping out in the reverse direction of the direction of press-fit insertion. The projections of the engagement portion 5 also, as shown in FIG. 1B, are fixed in the vertical direction that is the long direction of the press-fit contacts 6 so that the section 7a and the section 7b cannot move. When a downward force is exerted on the press-fit contacts 6 from above, the projections of the engagement portion 5 on the top side resist, and when an upward force is applied to the press-fit contacts 6 from below, the projections of the engagement portion 5 on the bottom side resist. Consequently, the press-fit contacts 6 are prevented from slipping out of the insulated housing 7, and therefore, the engagement portion 5 also is a press-fit contact 6 slip-stop prevention means.

Thus, as described above, the slip-stop prevention means is the shoulder portion 4a on the bulge portion 4 as well as the projections of the engagement portion 5. Moreover, for example, making the bulge portion 4 of narrower width then the engagement portion 5 creates a stepped portion at the portion where the width changes, and therefore this stepped portion also becomes a press-fit contact 6 slip-stop prevention means. Specifically, it is sufficient if slip-stop prevention means are present in the press-fit contacts 6.

In addition, it is sufficient if the above described slip-stop prevention means is provided with lock means so that the two sections 7a, 7b do not move in the long direction, which may be provided at one location only, and therefore one or the other of the bulge portion 4 and the engagement portion 5 may be provided.

Further, as a method for manufacturing the double-ended press-fit connector 1 according to the present invention, for example, the press-fit contacts 6 may be inserted into a mold and formed as a single integrated unit with the insulated housing 7. In that case, the assembly step of inserting the press-fit contacts 6 into the two sections 7a, 7b becomes unnecessary.

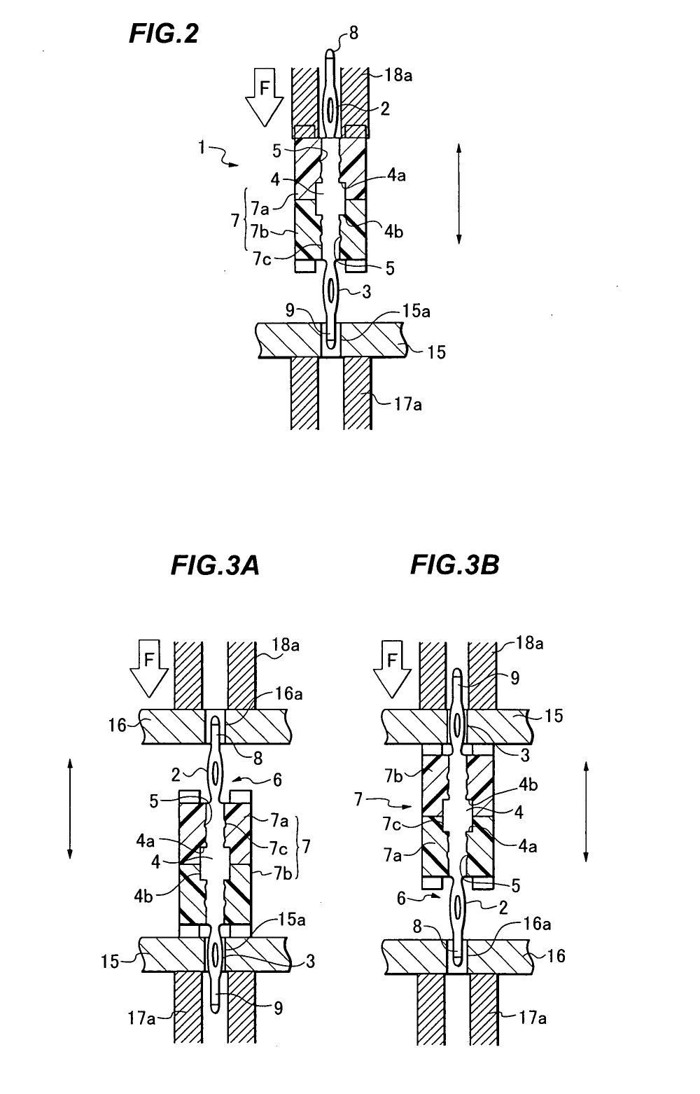

Next, a description is given of the procedure for inserting and mounting the double-ended press-fit connector 1 having the construction described above into and on printed circuit boards 15, 16. First, the press-fit contacts 6 are inserted into the sections 7a, 7b to assemble the double-ended press-fit connector 1. Then, as shown in FIG. 2, the printed circuit board 15 is placed on the receiving jig 17a and the introduction portions 9 of the press-fit contacts 6 of the double-ended press-fit connector 1 are aligned with the through holes 15a in the printed circuit board 15, and the double-ended press-fit connector 1 is pressed downward with the punch jig 18a.

There are no escape holes to which the polarity projections can escape in the receiving jig 17a, and similarly, there are no escape holes to which the polarity projections can escape in the punch jig 18a, either. This point differs from the jigs 17, 18 in the conventional example, rendering the process of making holes in the jig in the jig production step unnecessary.

When the punch jig 18a presses down on the top end surface of the insulated housing 7 of the double-ended press-fit connector 1, the pressing force is transmitted from the insulated housing 7 to all the press-fit contacts 6 through the shoulder portion 4a and the press-fit portions 3 are inserted into the through-holes 15a.

Next, as shown in FIG. 3A, the through-holes 16a in the printed circuit board 16 are aligned with the introduction portions 8 and the printed circuit board 16 is pressed downward with the punch jig 18a so as to press the press-fit contacts 6 into the through-holes 16a in the printed circuit board 16. At this time, the press-fit contacts 6 are pushed downward by a frictional force generated by the sliding contact between the through-holes 16a and the press-fit portions 2. However, the shoulder portion 4b of the press-fit contacts 6 is blocked by section 7b of the insulated housing 7 and thus the press-fit contacts 6 do not slip out of the insulated housing 7. In this manner the double-ended press-fit connector 1 is mounted on the upper and lower printed circuit boards 15, 16.

Moreover, the process is the same when, as shown in FIG. 3B, the printed circuit board 15 into which the double-ended press-fit connector 1 is inserted and attached is inverted to the punch jig 18a side and the printed circuit board 16 is placed on the receiving jig 17a side and mounted, in a state that is the reverse of that shown in FIG. 3A. Specifically, when the insulated housing 7 is pressed with the punch jig 18a through the printed circuit board 15, the section 7b on the top side of the insulated housing 7 pushes against the shoulder portion 4b of the press-fit contacts 6, which causes the press-fit portions 2 of the press-fit contacts 6 to be inserted into the through-holes 16a in the printed circuit board 16, thus mounting the double-ended press-fit connector 1 on the upper and lower printed circuit boards 15, 16.

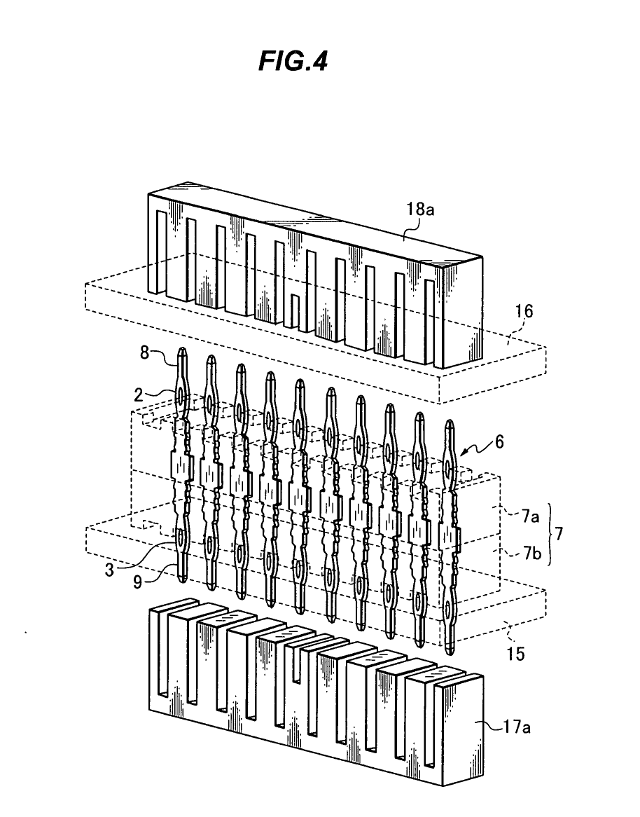

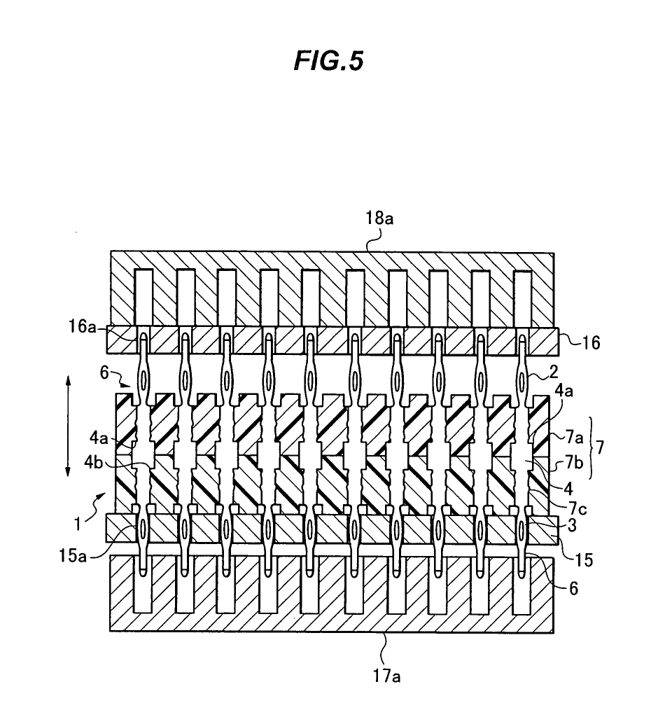

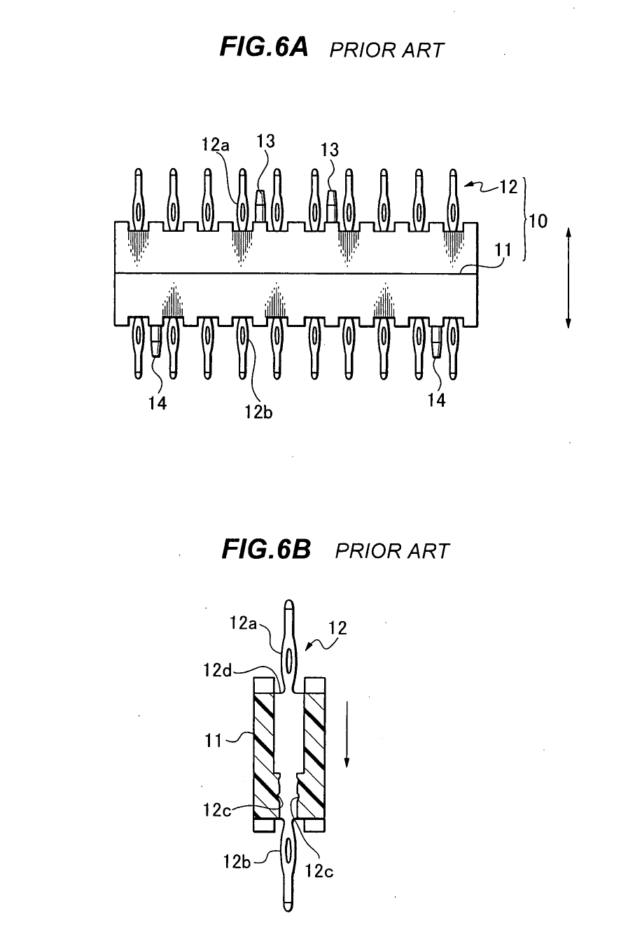

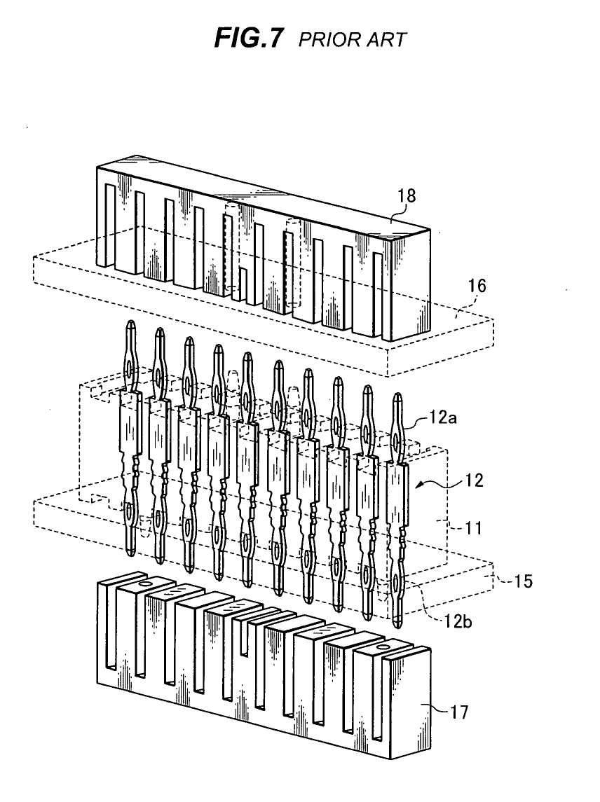

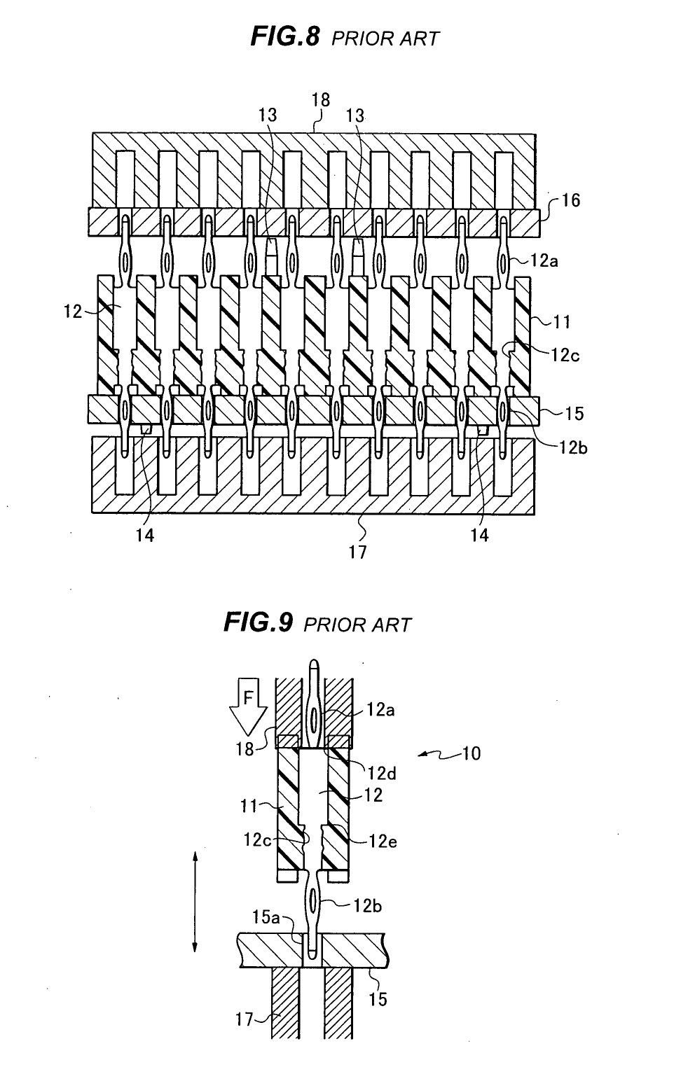

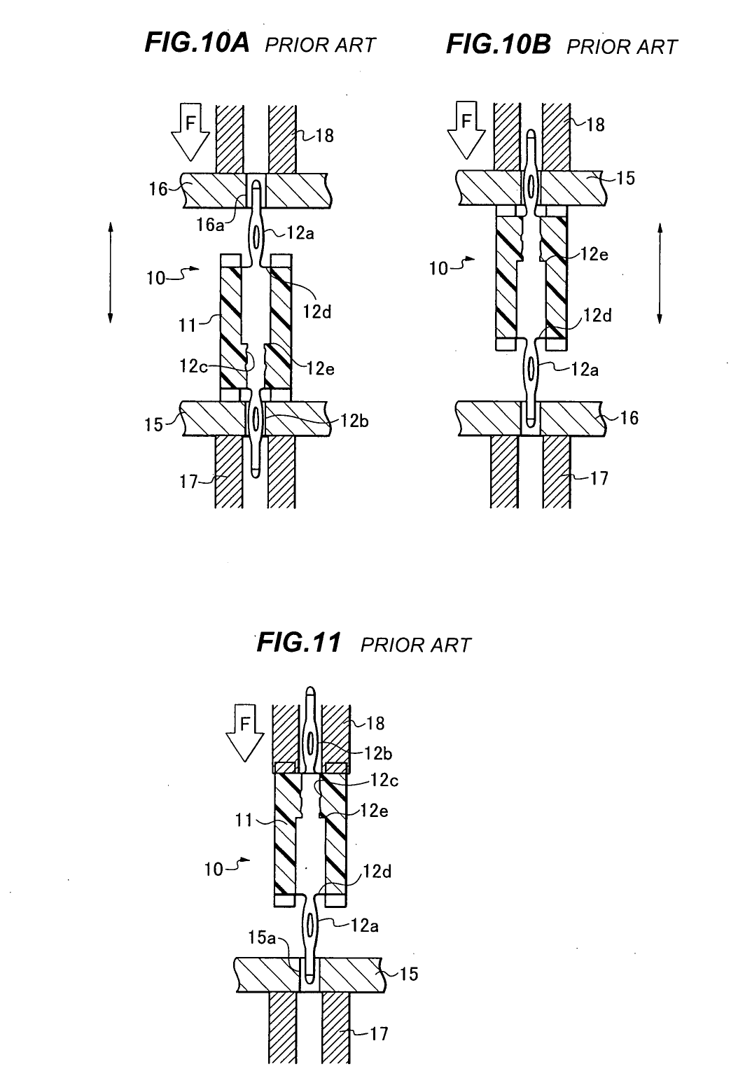

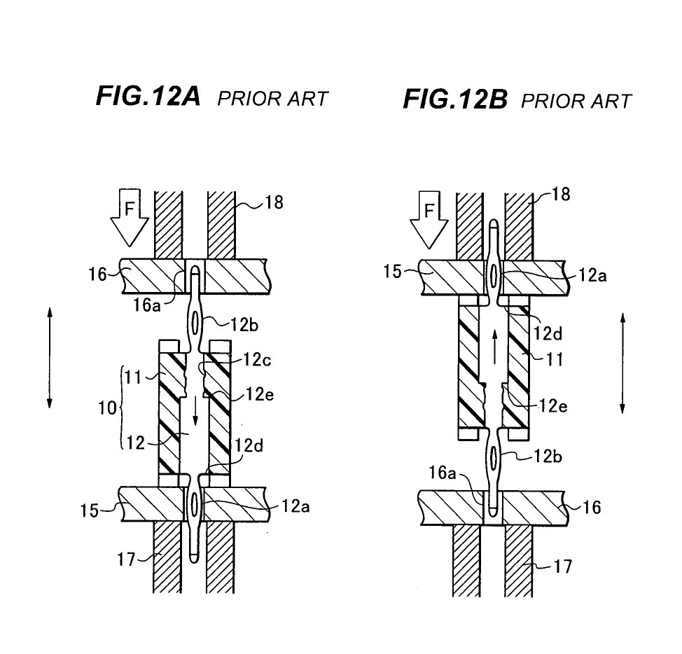

FIG. 4 and FIG. 5 show perspective and sectional views, respectively, of the press-fitting and mounting of the double-ended press-fit connector 1 on the printed circuit boards 15, 16. With the double-ended press-fit connector 1 according to the present invention, it is not necessary to determine the order of assembly, that is, which of the press-fit portions 2, 3 must be inserted in a printed circuit board first, and therefore the double-ended press-fit connector 1 may be turned upside down from the state shown in the drawings. Therefore, an operator can perform the task of inserting the press-fit contacts into the printed circuit boards 15, 16 without being at all concerned about polarity when inserting the double-ended press-fit connector 1.

As many apparently widely different embodiments and variations of the present invention can be made without departing from the spirit and scope thereof, it is to be understood that the invention is not limited to the specific embodiments thereof and described herein, except as defined in the appended claims.

1. A double-ended press-fit connector comprising:
an insulated housing in which multiple fixing holes for insertion of contacts are aligned;
and a plurality of press-fit contacts inserted in the fixing holes, the press-fit contacts each having at least a bulge portion of maximum width at a center of the press-fit contact in a long direction of the press-fit contact and a press-fit portion at each end side of the press-fit contact, each press-fit portion formed in an arc shape in a width direction of the press-fit contact,
shoulder portions that form steps provided at top and bottom ends of the bulge portion,
the fixing holes formed in a shape so as to accommodate engagement of the press-fit contacts and stop the press-fit contacts from slipping out of the insulated housing.

2. The double-ended press-fit connector according to claim 1, wherein the bulge portion is rectangular in shape.

3. The double-ended press-fit connector according to claim 1, wherein engagement portions having slight projections are provided on both outer sides between the bulge portion and the press-fit portion.

4. The double-ended press-fit connector according to claim 1, wherein the insulated housing is divided into two parts, upper and lower, along the center of the press-fit contact in the long direction of the press-fit contact,
the fixing holes provided in each of the upper and lower parts formed so as to be vertically symmetrical.

5. The double-ended press-fit connector according to claim 1, wherein the insulated housing is molded as a single integrated unit together with the press-fit contacts.

6. The double-ended press-fit connector according to claim 1, wherein each of the press-fit contacts has on a tip end side of the press-fit portion an introductory portion of narrower width than the press-fit portion.

7. The double-ended press-fit connector according to claim 2, wherein the insulated housing is divided into two parts, upper and lower, along the center of the press-fit contact in the long direction of the press-fit contact,
the fixing holes provided in each of the upper and lower parts formed so as to be vertically symmetrical.

8. The double-ended press-fit connector according to claim 2, wherein the insulated housing is molded as a single integrated unit together with the press-fit contacts.

9. The double-ended press-fit connector according to claim 2, wherein each of the press-fit contacts has on a tip end side of the press-fit portion an introductory portion of narrower width than the press-fit portion.
